(19) United States
(12) Patent Application Publication
(10) Pub. No.: US 2010/0290330 A1
(43) Pub. Date: Nov. 18, 2010

(54) APPARATUS AND METHOD FOR PERMANENTLY DELETING DATA OF OPTICAL DISK

(76) Inventors: Hyunseok Shin, Seoul (KR); Byeongrim Jo, Seoul (KR); Jyhyun Lee, Seoul (KR)

Correspondence Address: BIRCH STEWART KOLASCH & BIRCH, PO BOX 747, FALLS CHURCH, VA, 22040-0747, US

(21) Appl. No.: 12/811,649

(22) PCT Filed: Jan. 14, 2009
(86) PCT No.: PCT/KR09/00191

§ 371 Date: Jul. 2, 2010

(30) Foreign Application Priority Data
Jan. 14, 2008 (KR) 10-2000-0003790

(51) Int. Cl. G11B 27/00

(52) U.S. Cl. 369/83; G9B/27

(57) ABSTRACT

The present invention relates to a method for eternally erasing data recorded on an optical disk by generating an optical scratch on the optical disk. More particularly, the present invention relates to a method for eternally erasing data recorded on an optical disk by disturbing a laser beam at a predetermined frequency and amplitude while irradiating the laser beam having a predetermined power and at the same time moving a sled.

### TECHNICAL FIELD

The present invention relates to apparatus and method for eternally erasing data recorded on an optical disk by generating an optical scratch on the optical disk.

### BACKGROUND ART

In the optical disk (CD, DVD, BD, HD DVD), data regarding the security of an individual, company, etc. may be recorded. When the use of the data is completed, it may be necessary to destroy the optical disk on which the data is recorded.

Various methods are being used for eternally erasing the data recorded on the optical disk.

For example, a rewritable disc has an overwritable function capable of recording data several times on a record layer made of phase change material. In order to erase data, the rewritable disc uses a DC erase method in which data is overwritten by using a DC type laser.

Also, a write once disc can record data on a record layer made of pigment only once. In the write once disc, there is known a method making it impossible to recover data by overwriting arbitrary data on a recorded region to erase data.

However, the method of eternally erasing data using the overwriting has a limitation in that since the method erase data while searching an erase region and tracing a track of the optical disk, the erasing time is long.

Although the recorded data is erased, since there is a possibility that can recover the erased data by restoring a read-in region and a file system region of the optical disk, the method still has a serious limitation in an enterprise or individual who is careful concerning the data security.

As methods for destroying data, there are a method of scratching a surface of the optical disk using a sharp probe, a method of scratching a pigment region on a recorded region to destroy data, etc., but the method of scratching the pigment region may cause contamination due to the pigment and since the scratch may not completely erase data, the data recover may be possible.

As another method of eternally erasing data recorded on an optical disk, there is a method of generating an optical scratch while moving a sled after a servo operation of a track is stopped.

FIGS. 1 and 2 are schematic views for describing a method for generating an optical scratch according to a related art.

As shown in FIG. 1, while an optical disk 11 rotates at a predetermined velocity and a sled 13 moves, laser beam is irradiated to generate an optical scratch on the optical disk 11. The sled 13 is provided with an optical pickup 12.

The sled 13 is generally driven by a stepping motor (not shown). The stepping motor is a motor that can control movement by a predetermined angle using a pulse, but the stepping motor cannot be driven precisely in track unit over the optical disk.

That is, as shown in FIG. 2, a minimum driving unit of the sled 13 movable by the stepping motor exceeds each track unit. For example, in FIG. 2, a laser beam 17 having a predetermined power is focused on and irradiated onto a specific track, and is then focused on and irradiated onto a track next to three tracks passed 14 while moving the sled 13.

That is, since the laser beam is not irradiated onto the passed tracks 14, an optical scratch is not generated, so that data cannot be completely erased.

Although FIG. 2 shows that the minimum driving unit of the sled 13 is four tracks unit, the minimum driving unit of the sled may be in a range of several tracks to several hundreds tracks according to the specification of the stepping motor and the sled.

That is, since the related art method of eternally erasing data while moving the sled fails to generate an optical scratch on the optical disk, data erase cannot be performed with respect to an entire data region recorded on the optical disk.

Therefore, user's reliability on the apparatus of eternally erasing data may be lowered and security issue may be caused due to the possibility that the erased data may be restored.

### DISCLOSURE

### Technical Problem

The present invention is devised to solve the problem, and provides apparatus and method for eternally erasing data recorded on an optical disk effectively and rapidly.

### Technical Solution

To solve the problem, the present invention provides a method for eternally erasing data recorded on an optical disk.

In an embodiment of the present invention, a method for eternally erasing data recorded on an optical disk, the method include: stopping a tracking servo for the optical disk; controlling an output power of a laser beam to be irradiated onto the optical disk; and generating an optical scratch on the optical disk by irradiating the laser beam on the optical disk while disturbing the laser beam.

In another embodiment of the present invention, an optical disk apparatus includes: an optical pickup generating and irradiating a laser beam, generating an optical scratch in a data erase mode, and detecting a signal recorded on the optical disk using the laser beam; a signal processing unit reading the signal detected by the optical pickup and restoring digital data from the read signal; a spindle motor rotating the optical disk at a high velocity; a sled motor moving a sled in a horizontal direction; a motor driver applying a driving voltage to the spindle motor or the sled motor and in a data eternal erase mode, applying a voltage such that the laser beam irradiated from the optical pickup is disturbed at a predetermined frequency and amplitude; and a controller controlling an overall operation of the optical disk apparatus and in the data eternal erase mode, controlling the sled motor to disturb the sled.

### ADVANTAGEOUS EFFECTS

According to the present invention, the data recorded on the optical disk can be erased rapidly and eternally.

Also, according to the present invention, the data erase effect can be enhanced by expanding the region where the optical scratch is generated.

### DESCRIPTION OF DRAWINGS

FIGS. 1 and 2 are schematic views for describing a method for generating an optical scratch according to a related art.

FIG. 3 is a block diagram of an optical disk apparatus according to an embodiment of the present invention.

FIGS. 4 and 5 are schematic views for describing a method for eternally erasing data recorded on an optical disk according to an embodiment of the present invention.

FIG. 6 is a flow diagram illustrating a method for eternally erasing data recorded on an optical disk according to an embodiment of the present invention.

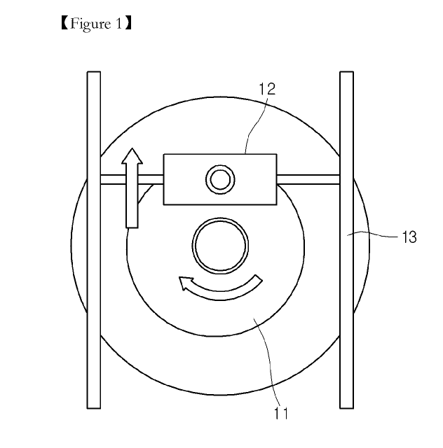

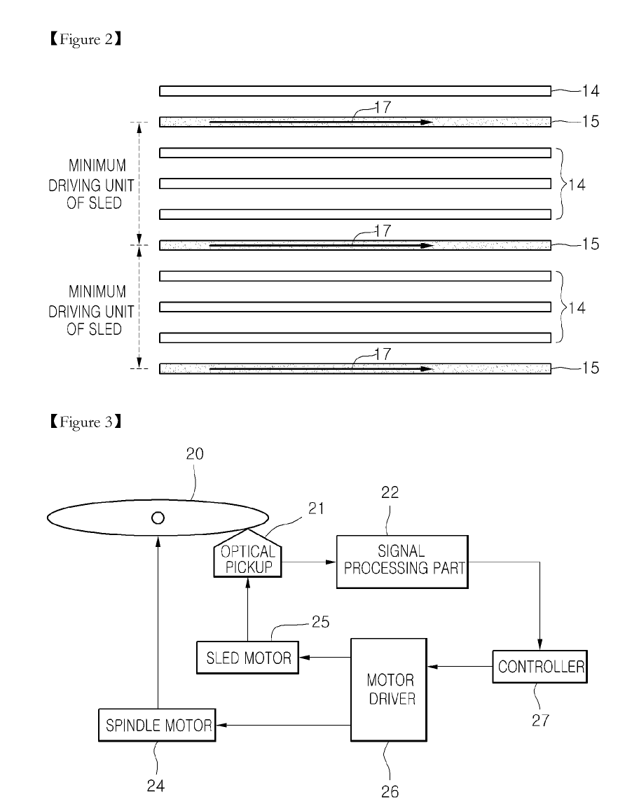

### BEST MODE

The present invention relates to apparatus and method for eternally erasing data recorded on an optical disk by generating an optical scratch rapidly and effectively.

Exemplary embodiments of the present invention will be described below in more detail with reference to the accompanying drawings so that those skilled in the art to which the present invention pertains easily carry out the technical spirit of the present invention.

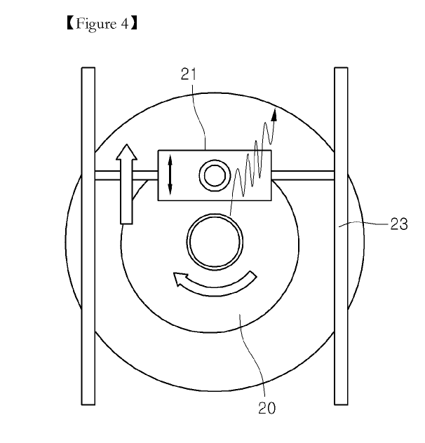

FIG. 3 is a block diagram of an optical disk apparatus according to an embodiment of the present invention.

The optical disk apparatus according to the present invention is configured to include an optical pickup 21 for generating and irradiating a laser beam, generating an optical scratch in a data erase mode, and detecting a signal recorded on an optical disk 20 using the laser beam reflected by the optical disk 20, a signal processing unit 22 for reading the signal detected by the optical pickup 21 and restoring the detected signal to digital data, a spindle motor 24 for rotating the optical disk 20 at a high velocity, a sled motor 25 for moving a sled in a horizontal direction, a motor driver 26 applying a driving voltage to the spindle motor 24 or the sled motor 25 and in a data eternal erase mode, applying a voltage to disturb the laser beam irradiated from the optical pick up 21 to a predetermined frequency and an amplitude, and a controller 27, in the data eternal erase mode, controlling the sled motor 25 to disturb the sled.

The optical pickup 21 includes a laser beam source, such as a laser diode, an object lens, a collimator lens, a beam splitter, etc.

In the data eternal erase mode according to the present invention, the optical pickup 21 increases the power of the laser beam source to a level more than a power level of a write mode according to a control of the controller 27.

The signal processing unit 22 combines RF signals detected by the optical disk to detect a binary play signal and a servo error signal and decode the binary play signal to digital data.

The spindle motor 24 rotates the optical disk at a high velocity so that data recorded on the optical disk 20 can be read by the optical pickup 21.

The sled motor 25 moves the sled provided with the optical pickup 21 in a direction crossing the optical disk 20.

The motor driver 26 applies a proper voltage to the spindle motor 24 or the sled motor 25 to drive the spindle motor 24 or the sled motor 25. In particular, the motor driver 27 disturbs the voltage applied to the sled motor 25 such that the voltage has a predetermined amplitude and frequency and thus the sled driven by the sled motor 25 is disturbed.

Disturbance amplitude and disturbance frequency of the laser beam irradiated from the optical pickup 21 may be controlled by the motor driver 26 controlling the voltage applied to the sled motor 25.

In another embodiment, the erasing apparatus may be configured such that the optical pickup 21 is equipped in an element other than the sled and the laser beam irradiated from the optical pickup 21 is disturbed by the motor driver 26 or another element disturbing a voltage applied to the element in which the optical pickup 21 is equipped.

The controller 27 controls an overall operation of the optical disk apparatus according to read mode, write mode, or data eternal erase mode. In the data eternal erase mode, the controller 27 stops a tracking servo for the optical disk and operates only a focus servo.

In the data eternal erase mode according to the present invention, the controller 27 controls the sled to be moved from an inner circumference of the optical disk to an outer circumference.

When the data eternal erase mode is ended, the controller 27 recovers the tracking servo to a normal state and stops the moving of the sled.

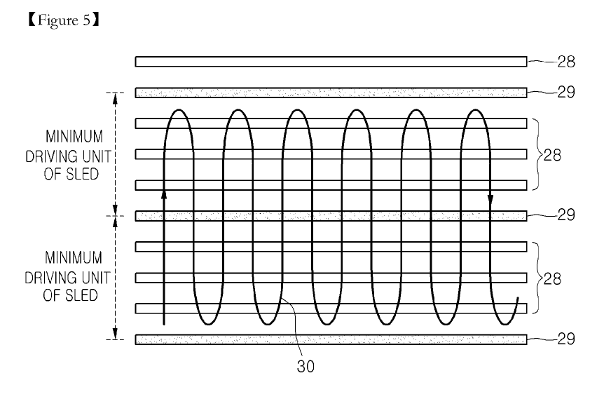

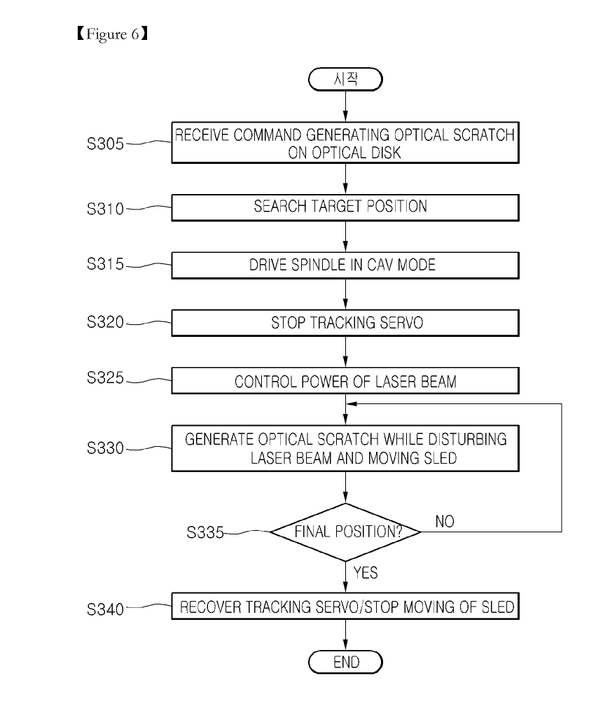

FIGS. 4 and 5 are schematic views for describing a method for eternally erasing data recorded on an optical disk according to an embodiment of the present invention.

As shown in FIG. 4, an optical scratch is generated on the optical disk 20 while rotating the optical disk 20 at a predetermined velocity and moving the sled 23 provided with a laser beam source. At this time, by vibrating the sled 23, a laser beam irradiated from an object lens OL included in the sled 23 to a surface of the optical disk 21 is disturbed.

Otherwise, by applying wobbling to a tracking driving signal used in the tracking servo, the irradiated laser beam may be disturbed.

The described methods are only exemplary methods to easily carry out the present invention, and accordingly, the present invention may include all possible methods capable of disturbing the irradiated laser beam.

As shown in FIG. 5, by disturbing the irradiated laser beam to a predetermined frequency and amplitude, it is possible to generate an optical scratch even in a track 28 existing between tracks 29 corresponding to a minimum driving unit of the sled 23. The laser beam may be disturbed by disturbing the sled 23 provided with the laser beam source to a predetermined frequency and amplitude. Otherwise, by selectively disturbing the optical disk 20, it is possible to disturb a position where the laser beam is irradiated. Line 30 shown in FIG. 5 indicates a trace of positions where the disturbed laser beam is irradiated.

The disturbance amplitude and disturbance frequency of the irradiated laser beam are controllable. For example, by increasing the disturbance frequency to increase the number of disturbance, it is possible to generate an optical scratch more precisely. Also, by increasing the disturbance amplitude, it is possible to increase the number of track capable of generating an optical scratch.

Further, the laser beam may be disturbed at constant amplitude and frequency as shown in FIG. 5, and in an embodiment, the laser beam may be disturbed in the form having a variable amplitude and frequency.

Therefore, by properly controlling the two factors, an optical scratch may be generated on an entire region of the optical disk to eternally erase data.

At this time, the laser beam may have a predetermined power, and preferably, the power of the laser beam may be controlled to an output power more than the write power.

The write power corresponds to a power level that may cause a phase change of a material constituting the optical disk, and may be changed according to the optical disk, the embodiment, or the like.

Also, the sled 23 may be moved from the inner circumference of the optical disk 20 to the outer circumference. In an embodiment, in order to completely erase data, the erase process may be performed once more from the outer circumference of the optical disk 20 to the inner circumference.

Although FIG. 5 shows that the optical scratch is generated in three upper tracks and three lower tracks, it is only an exemplary one for easy description of the present invention and the present invention is not limited thereto. That is, in an embodiment, the irradiation range of the laser beam may be expanded in a range of several tracks to several thousands tracks.

Also, the optical disk 20 may have a predetermined eccentric component, but in an embodiment of the present invention, it is assumed that such an eccentric component does not exist.

FIG. 6 is a flow diagram illustrating a method for eternally erasing data recorded on an optical disk according to an embodiment of the present invention.

When a command for generating an optical scratch on the optical disk is received (S305), the position of a target where the optical scratch is being generated is searched (S310). Alternatively, the method may include, prior to searching the position of the target, determining whether or not the optical disk is inserted.

The command for generating the optical scratch on the optical disk is, for example, a command for eternally erasing data on the optical disk. The command may be inputted by a user, or in an embodiment, the command may be loaded and performed by another application.

Alternatively, in the case of intending to generate the optical scratch only on some region of the optical disk according to an embodiment, the optical pickup searches a start position of the some region and controls the position such that the generation of the optical scratch is performed at the start position.

Next, a spindle is driven at a constant angular velocity (CAV) (S315). In the method of generating the optical scratch while moving the sled as in the embodiment of the present invention, it is more preferable to drive the spindle at the CAV than to drive the spindle at a constant linear velocity (CLV).

Next, the tracking servo is stopped (S320) and the power of the irradiated laser beam is controlled (S325). At this time, the erasing method may further include stopping the tracking servo and driving only the focus servo.

Also, the power of the irradiated laser beam may be preferably controlled to an output power more than the write power.

If the above operation is completed, the laser beam the power of which is controlled is disturbed and an optical scratch is generated on the optical disk while moving the sled in a predetermined direction (S330). As described above, it is possible to move the sled from the inner circumference of the optical disk to the outer circumference, and in an embodiment, it is also possible to again move the sled from the outer circumference to the inner circumference.

While moving the sled and generating the optical scratch, it is determined whether or not the sled arrives at a final position of data region to be erased (S335). When it is determined that the sled does not arrive at the final position, the operation of generating the optical scratch is repeated. Also, when it is determined that the sled arrives at the final position, the stopped tracking servo is recovered and the moving of the sled is stopped (S340).

Alternatively, in an embodiment, the operation may be ended by ejecting the optical disk on which the optical scratch is generated.

While the present invention has been particularly shown and described with reference to exemplary embodiments thereof, it will be understood by those of ordinary skill in the art that various changes in form and details may be made therein without departing from the substantial features of the embodiments.

The scope of the invention is defined by the appended claims, and all differences within the scope will be construed as being included in the present invention.

1. A method for eternally erasing data recorded on an optical disk, the method comprising:
stopping a tracking servo for the optical disk;
controlling an output power of a laser beam to be irradiated onto the optical disk; and
generating an optical scratch on the optical disk by irradiating the laser beam on the optical disk while disturbing the laser beam.

2. The method of claim 1, wherein the controlling the output power of the laser beam comprises controlling the output power of the laser beam to a power level more than a write power.

3. The method of claim 1, wherein the laser beam is disturbed by disturbing a sled provided with a laser beam source.

4. The method of claim 1, further comprising moving the sled from an inner circumference of the optical disk to an outer circumference.

5. The method of claim 1, if the data eternal erase is ended, further comprising restoring the tracking servo and stopping the moving of the sled.

6. The method of claim 1, wherein the stopping of the tracking servo for the optical disk further comprises stopping the tracking servo and operating only a focus servo.

7. The method of claim 1, further comprising moving the sled from an inner circumference of the optical disk to an outer circumference.

8. The method of claim 1, wherein disturbance amplitude and disturbance frequency of the irradiated laser beam are controllable.

9. An optical disk apparatus comprising:
an optical pickup generating and irradiating a laser beam, generating an optical scratch in a data erase mode, and detecting a signal recorded on the optical disk using the laser beam;
a signal processing unit reading the signal detected by the optical pickup and restoring digital data from the read signal;
a spindle motor rotating the optical disk at a high velocity;
a sled motor moving a sled in a horizontal direction;
a motor driver applying a driving voltage to the spindle motor or the sled motor and in a data eternal erase mode, applying a voltage such that the laser beam irradiated from the optical pickup is disturbed at a predetermined frequency and amplitude; and
a controller controlling an overall operation of the optical disk apparatus and in the data eternal erase mode, controlling the sled motor to disturb the sled.

10. The optical disk apparatus of claim 9, wherein the laser beam generating the optical scratch has a power which is more than a write power.

11. The optical disk apparatus of claim 9, wherein the optical pickup is equipped in the sled, and the motor driver applies a voltage to the sled such that the sled is disturbed at a predetermined frequency and amplitude.

12. The optical disk apparatus of claim 9, wherein the sled motor moves the sled from an inner circumference of the optical disk to an outer circumference.

13. The optical disk apparatus of claim 9, wherein the controller stops the tracking servo for the optical disk and operates only a focus servo in the data eternal erase mode.

14. The optical disk apparatus of claim 9, wherein the controller recovers the tracking servo to a normal state and stops the moving of the sled when the data eternal erase mode is ended.

15. The optical disk apparatus of claim 9, wherein disturbance amplitude and disturbance frequency of the irradiated laser beam are controllable.
